(19) United States
(12) Patent Application Publication
(10) Pub. No.: US 2010/0250393 A1
(43) Pub. Date: Sep. 30, 2010

(54) Networked task management

(76) Inventors: Murali Pandian, Herndon, VA (US); Arulnambi Kaliappan, Elkrrdge, MD (US); Pattabhi Boinpally, Reston, VA (US); Clayton Bodine, Aldie, VA (US); Andi Giri, Chantilly, VA (US)

Correspondence Address: Ugandhar Chalasani, 1249 Reston Avenue, Herndon, VA, 20170, US

(21) Appl. No.: 12/384,014

(22) Filed: Mar. 31, 2009

Related U.S. Application Data
(60) Provisional application No. 61/072,375, filed on Mar. 31, 2008.

(51) Int. Cl. G06Q 30/00; G06F 15/16; G06F 21/00

(52) U.S. Cl. 705/27; 709/204; 726/27; 705/26

(57) ABSTRACT

A system for network-based task management is disclosed. The system for network-based task management includes a task management server comprising a task management content generation module, a task management content access module, a conversation module, and a contact management module. The task management content can be tightly coupled to other functionality such as conversations and payment options associated with the task content. A method for network-based task management is also disclosed.

### CROSS REFERENCE TO RELATED APPLICATIONS

This application claims the benefit of U.S. provisional application No. 61/072,375, filed on Mar. 31, 2008 which is hereby incorporated by reference in its entirety.

### TECHNOLOGY AREA

This invention is related to network-based task management.

### BACKGROUND

The Internet is moving into the Web 2.0 world. One of the axioms of Web 2.0 applications is that information should find the relevant user rather than the user looking for it. Also, applications should allow users to have greater control over the information they created. In order for Web 2.0 applications to achieve these objectives, they need to overcome some of the shortcomings inherent in traditional Web Applications and the way they are used. Some of those issues are as described below.

Limited user-based customization of content: Websites which allow users to create content have limited ways of allowing the creators to control access to all or parts of the content they created. Usually, either all or none of the content is viewable by the consumers of the content. Also, content creators are restricted in the types or units of information that can be created as part of the content.

Need for user action to see updates: Content that is dynamic can change often. Consumers of this content typically have to refresh the web page they are viewing or re-enter a previously visited website in order to see the updates. This becomes a problem when some key piece of content such as a status field gets updated, and the user is unaware of this and has not proactively checked the content for updates to the status.

Separation of information from related communication: Web users communicate with each other about some information that they may have common cause with, such as a classified ad, a blog entry, an event invitation, and so on, which may all be represented as one or more web pages. Traditionally, this communication is done online through email, comments functionality, or message boards, which may or may not be integrated into the website containing the information. Even with integration, these modes of communication have their own limitations. The lack of integration of these traditional online communication methods and their inherent limitations lead to separation of the information from related communication, making it harder for users to communicate relevantly and in a timely manner.

Lack of simple integration with payment services: Certain individual web users want to do commerce online by selling products or services. Other individuals or entities may have to do funds collection online for events or charities or other purposes. Simple, affordable payment services which can be integrated easily into the relevant information presentations are needed for these users. Existing payment solutions are difficult to integrate by the layman user, and carry high costs given the online transaction security requirements and related risk perceptions of credit card companies and banks.

Registration requirements: Websites which offer customization of content and user-specific profiles and associated services, require registration of users and setting up of profiles using personal information supplied during registration. This information is collected sometimes even when no sensitive financial or personal information is stored in the user profile. This creates a hurdle to increasing the user base of a website and offering advanced features even to unregistered users, as the general web user is struggling with managing memberships with multiple such websites, and is generally less inclined to register and divulge personal information due to the convenience and privacy factors, and also does not want to be implicitly signed up for intrusive marketing efforts like spam email.

Lack of easy addressing for dynamic content: Web pages containing content which is dynamic, such as those generated from information stored in a database, and which can be updated by the content creators, cannot be referenced by simple and short URL addresses. This makes it difficult to remember and reference them easily from other web pages and sites. Also, the creators of those web pages do not have the ability to customize the URL addresses by which those pages can be accessed.

### BRIEF SUMMARY OF THE INVENTION

The present invention addresses many of the problems associated with conventional web-based task management systems discussed above. The present invention is a network-based task management system which includes a task management server comprising a task management content generation module, a task management content access module, a conversation module, and a contact management module. The task management content can be tightly coupled to other functionality such as conversations and payment options associated with the task content. A method for network-based task management is also disclosed.

By enabling the developer of web-based task management content to bring together, within a single context, many of the aspects needed for effective task management, the present invention makes substantial improvements over the conventional systems. The present invention can be used for various applications including, but not limited to, online address books, classified advertisements, web pages for events/groupings/classes/announcement, travel profiles, job listings, resume postings, online contact cards, blog reader subscriptions and communication, and forums/message boards.

### BRIEF DESCRIPTION OF THE DRAWINGS

The following drawings illustrate example aspects of embodiments of the present invention.

FIG. 1 illustrates example uses of the present invention.

FIG. 2 illustrates the message/activity flow of a transaction for selling an item through the use of a classified advertisement according to an embodiment of the present invention.

FIG. 3 illustrates the layered software architecture of a task management server according to an embodiment of the present invention.

FIGS. 4a, 4b, and 4c, illustrate a web page for a classified advertisement created using a task management server according to an embodiment of the present invention.

FIG. 5 illustrates a task management system according to an embodiment of the present invention.

FIG. 6 illustrates a flowchart of processing steps for task management, according to an embodiment of the present invention.

### DETAILED DESCRIPTION OF THE INVENTION

As the functionality and sophistication of the Web grows, numerous interactive applications including various task management applications are deployed on the web. Classified sales, auctions, event management, are example task management applications. The present invention, in one embodiment, is a Web 2.0 system that enables the easy creation and addressing of dynamic and interactive web pages. The features of the system are designed to overcome the issues of conventional web applications. Some of the weaknesses of conventional system, that the present invention is designed to overcome are mentioned in the background section above. Embodiments of the present invention provide web users with ways to easily create and update content, make use of payment services to conduct commerce, and communicate effectively and easily with others.

For the most effective deployment of these applications, aspects of content, communication, community, and commerce must be brought together in a single platform. The present invention is a network-based task management system that allows the web content owner to tightly integrate aspects of content, communication, community and commerce in a seamless manner to deploy their applications to maximum effect. For example, in one embodiment of the present invention, the communication is incorporated within the context by facilitating one-to-one, one-to-many, many-to-one, and many-to-many conversation directly from within the context of the task management application.

In one embodiment the present invention is a web-based task management system, referred to herein as the IPDP (Interactive Portable Dynamic Pages) system. The name IPDP captures the nature and benefits of the web pages/profiles created by the system. Example uses of the IPDP system relating to a classified item sale include, but are not limited to, the following:
Using the IPDP system, a classified item seller can develop a web page that describes the item for sale, the conditions of sale, and payment options. The IPDP system also enables the classified seller to incorporate a conversation feature that allows the classified seller to reach potential classified buyers on one-to-one basis or one-to-many basis. The conversation is incorporated directly into the web-page such that each classified buyer can view the conversation or conversations for which he is authorized within the web-page, i.e., within content of the classified item.
After having created and deployed the web-page for the sale of the classified item, the classified seller can notify potential classified buyers and provide them with the address and in some cases, also any credentials that may be used to access the web-page.
The address or addresses provided to the potential buyers can be to dynamic content, such as the items or the prices of the items for sale where those can change over the duration of the sale period, or seller's contact information, or a dynamic link that can automatically place a call or send a message to the seller without revealing the sellers phone number.
The classified seller can maintain a list of potential classified buyers including information about each of those potential classified buyers. The information can include name and address information, individual preferences of the buyers, payment details such as credit card information.
Web-page can have the content such as the items for sale, conversation with the buyer, buyer information from the sellers list of potential buyers, and payment capabilities integrated. The integration of several of the functionalities enables the classified buyer to purchase the item without having to manually enter additional information.
Using the IPDP system, a user can design a form and publish. Any of intended participants can fill the form from their profile most of the information automatically. Creator of the page can communicate with participants with out knowing their real contact information also.

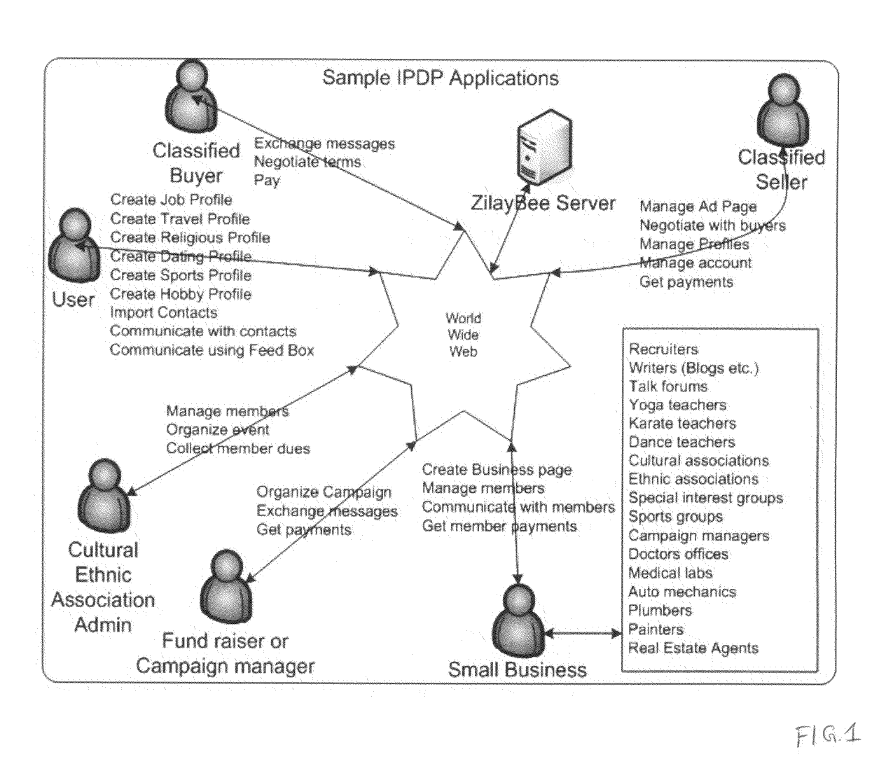

Other example applications of the IPDP system can include a mortgage lender creating a web page to get a house owner's current mortgage rates. Based on rate changes and configuration options, the IPDP system would automatically inform both the lender as well as the house owner about the refinancing options. Yet other example applications can be for online address books, web pages for events, travel profiles, job listings, resume postings, online contact cards, blog reader subscriptions and communication, forums and message Boards. A person of skill in the art will understand that numerous applications are made possible by the present invention, for example, by using the IPDP system. FIG. 1 illustrates an IPDP server coupled to the Web, and several applications that may be supported using the services of the IPDP system.

A general overview of the features of the present invention is provided in the following subsections. Some of the following features can be utilized by users without explicitly registering with the system and creating an online account.

### Web Page Creation

The IPDP system allows for users to create web pages for different purposes, and provides ways to update those pages. Each category of web pages has predefined fields that are relevant for its purpose. The user can fill in appropriate values for those fields. In addition, the system may allow the user to create custom fields and include them as part of the web page. In addition to the text-based fields, the system also allows users to include multimedia content such as images, audio and video as part of the page.

### Web Page Addressing

Once the web page is created by a user, the IPDP system offers the option of creating a custom URL address by which that page can be accessed. If a custom URL is not specified by the user, the system generates a compact URL automatically for the web page. Publishing the web page in other websites thus becomes as simple as adding a link pointing to the URL for the web page.

### Personal Profile

A specialized web page that the IPDP system allows registered users to create and store in their accounts is a personal profile containing predefined contact information fields such as, but not limited to, email addresses, telephone numbers, and mailing address. This personal profile can be accessed by a custom URL address, much like other web pages created by users of the system. Access to all or part of the personal profile is controlled by access control rules set up by the creating user.

### Contacts Book (SmartBook)

The IPDP system has a built in contact management module or contacts book called SmartBook which registered users can use to create and store their contacts. Each SmartBook entry stores contact and other personal information. If a contact is also a registered user of the system, then the system automatically keeps that contact information up-to-date by synchronizing the contact information with the personal profile of that user. The system allows a user to share his personal profile with the SmartBooks of his contacts to which his profile is published. Contacts in a SmartBook can be categorized into groups. Users can share links and other resources with specific contacts using the notification feature described below.

### Access Control

The IPDP system allows users to set up custom access control lists on individual fields or groups of fields contained in web pages created by them. Content creators can restrict or allow specific users listed in their SmartBooks, and also users who may have only communicated with them through associated conversation modules or FeedBoxes (see below), to view certain fields in web pages. This feature allows creators to control who can view updates to those field values. A use case for this field-level access control may be to only allow certain recruiters among everyone who may have contacted a user through a resume profile to view the current availability status of the job candidate.

### Automatic Refresh

Certain fields in a web page, as well as fields which are part of the naming of a URL address, can be marked as auto-refresh by the page creator, whereby the IPDP system will utilize Web 2.0 technologies to refresh the values of only those fields in the display of that web page on the client side, instead of requiring a full page refresh initiated by the user to see the updates to the field values. As a use case, this allows a user (such as a potential buyer of a item listed in a classified advertisement) to automatically get the sold status of a classified ad without having to refresh the ad page in his web browser. The system pushes the content change to the user, unlike conventional websites which require the user to refresh the web page and pull the content change.

### Conversations (FeedBox)

The IPDP system has a threaded conversations feature referred to as a conversation module or FeedBox which allows a user to communicate with the viewers of a web page he created through the system on the same page itself, without the need for an external communication medium like email. FeedBox combines the individual message exchange benefits of email with the group communication features of a message board. As the FeedBox can be integrated easily into a web page created using the system, communication about the information in the web page is located alongside that information itself, achieving integration of the information and its associated communication. Web page viewers wanting to communicate with the creator/owner of a web page need to enter an email address as the identifying information before they can initiate communication with the creator/owner through the FeedBox feature. Exchanged messages are grouped into conversations by topic and participating users, forming a conversation thread with multiple messages. Creators of web pages have administrative control over the FeedBox conversations in those pages, with features like deleting conversations, marking conversations as spam, and blocking abusive users. FeedBox messages may also be delivered to email addresses in addition to being displayed on the web page where they were posted. Unregistered users of the system can use the FeedBox feature by providing just an email address. They can also view all conversations they have been part of by providing a password. This allows them to securely view a consolidated list of all their previous conversations without going through the full registration process. This FeedBox feature facilitates users in limiting or eliminating spam messages. This FeedBox feature users will have the ability to block spam messages by suppressing messages originating from certain sources.

### Payment Services

Users of the system may want to include ways to pay for a service or product on the web pages they create. The IPDP system includes a payment service module which provides payment processing services for credit cards and direct bank account debiting. Clients viewing the web pages can pay for the product or service announced in the page using the payment options. Users accepting payments through web pages they created with the system will have to be registered to set up the payment services feature. Payment services can also be set up to process recurring payments for services which require periodic payments, such as subscriptions, memberships or classes. By offering payment services to users, the system provides an end-to-end solution for users who want to conduct commerce online on an individual or small-business level.

### Notifications (Alerts)

The IPDP system can generate notifications (alerts) for events that happen in the system. Examples of such events are: a new message being sent in an existing FeedBox conversation; a new conversation being started; a status field value changing on a web page; a resource such as a web page link being shared by a SmartBook contact; a financial transaction being finalized through payment services; a blog being updated. Users of the system can configure what types of events they would want to receive notifications for (subscription to notifications).

### Online Bookmarks

The IPDP system allows users to store their bookmarks (links) in their accounts, thus allowing the users to access those links from wherever they can access their accounts. Bookmarks or favorite links are tied to the web browser (client application) on a specific computer and cannot be accessed from anywhere else. This online bookmarks feature serves that need. Online bookmarks can also be shared with contacts.

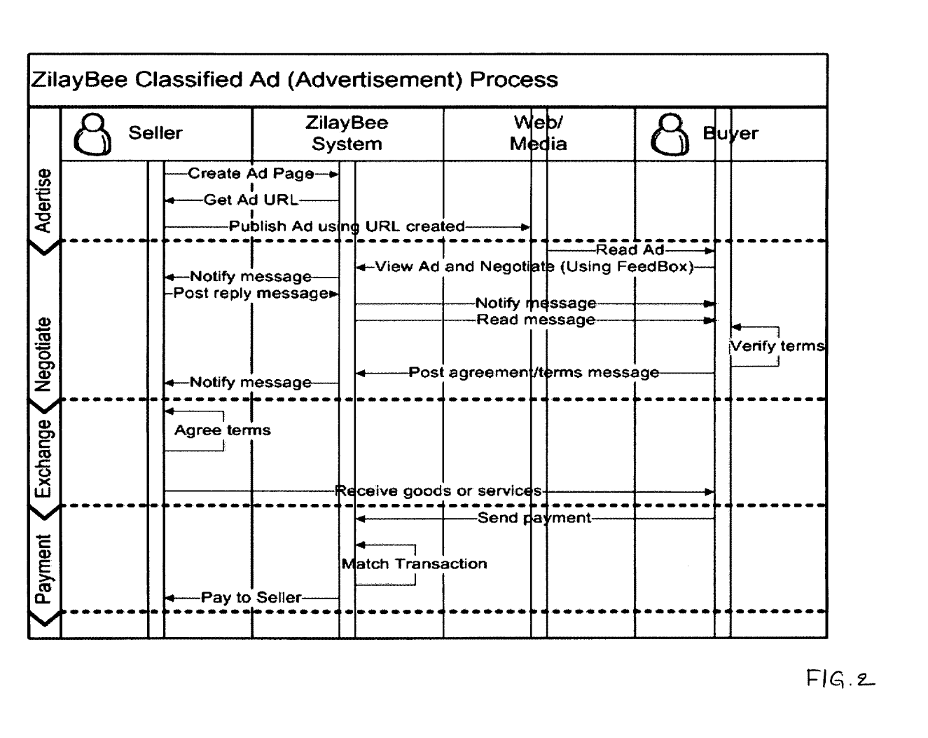

FIG. 2 is a message flow diagram of an embodiment of the present invention as used in a classified advertisement application. The application involves the IPDP system, Web media such as various web sites and email facilities, a buyer and a seller. The transaction can be broadly subdivided into four stages: an advertising phase, a negotiation phase, an exchange of goods stage, and a payment stage. If the item being sold is an item that is not saleable purely electronically, then the IPDP system can be extensively used in all stages except for the exchange of goods stage. If the item being sold is an item that is saleable purely electronically, then the IPDP system can be extensively used in all stages of the transaction.

In the advertising stage, the seller logs into the IPDP system and creates a web page for the classified advertisement. The IPDP system stores the web page and any other relevant data, and returns a uniform resource locator (URL) to the seller. The seller uses this URL to advertise the web page created and stored in the IPDP system. Seller can either use this URL to automatically syndicate to different web sites and print/other media. For example, the seller may purchase advertising on a search engine and place the URL along with the advertisement.

In the negotiations stage, a buyer accesses the stored web page having the classified advertisement. For example, the buyer may have clicked on the URL set in place by the seller in an advertisement. After any necessary authentication and authorization, the buyer is allowed to read the classified advertisement. Having viewed the classified advertisement the buyer is also able to negotiate terms in a conversation with the seller, for example, using the conversation module (feedbox feature) of the present invention. During this negotiation (and/or conversation) each time the buyer or seller posts a message in the feedbox, an alert may be generated (for example, using email) to notify the other party as to a change on the relevant web page. After some conversation exchanges, the buyer posts his acceptance upon the web page, and the seller is duly notified.

In the exchange of goods, the IPDP system may or may not be directly used. Items that can be sold purely electronically such as electronic books, digitized music, etc., can themselves be transferred using the IPDP system. More conventional items that are not purely electronic may be transferred outside of the IPDP system.

Finally, in the payment stage too IPDP is capable of being used. For example, the buyer may select a payment option such as a credit card payment option which was provided on the web-page for the classified advertisement. If the buyer is a registered user and his information such as address and telephone number are already known by the system, then much of the information needed on the payment processing form can be prefilled by the IPDP system itself.

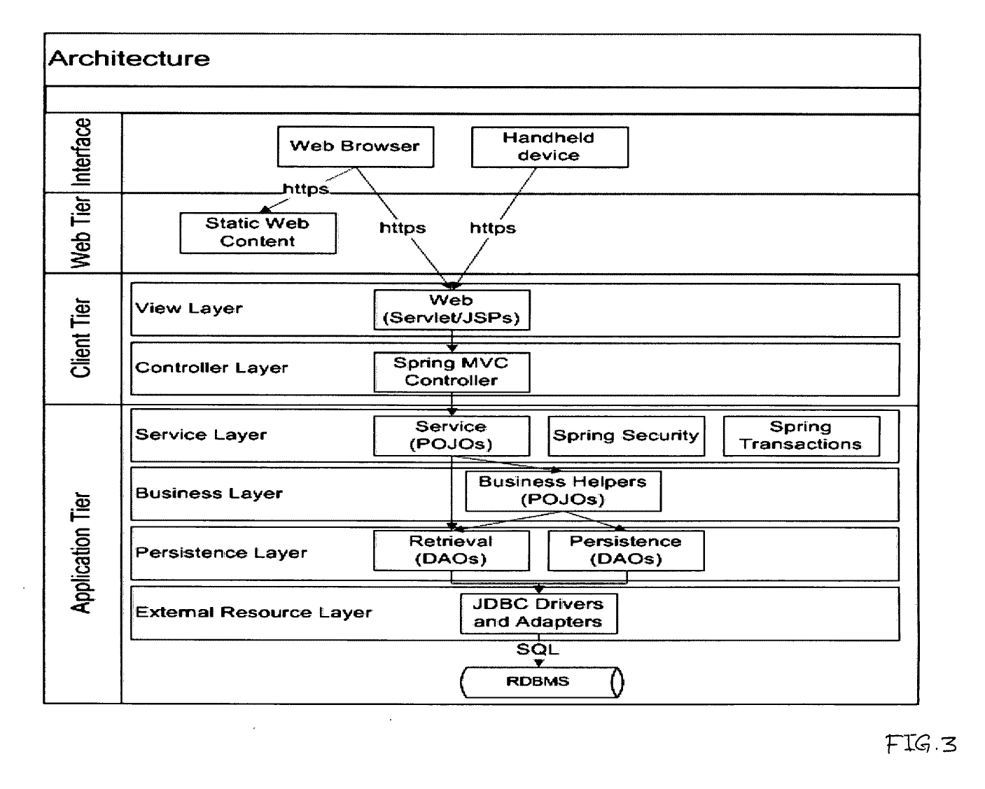

FIG. 3 shows a layered software design of the IPDP server according to one embodiment of the present invention. As shown in FIG. 3, a web client such as a buyer or seller using an IPDP service can access the services of the IPDP system through static web content in a web tier or dynamic web content generated using a layered design. The web tier or layer can include, for example, the advertisement placed in other web locations which are hyperlinked to the IPDP server using an IPDP system provided URL. In the example of FIG. 2, the advertisement placed in a search engine page announcing the classified advertisement may be considered as static web content.

A client tier can include a view layer and a controller layer. The controller layer handles all web requests. It handles the request and response objects and delegates to the service layer for performing the business logic. Controllers handle concurrent requests and are generally implemented as singleton classes; they do not maintain state during the processing of requests. The Controller is agnostic of the view rendering technology, be it Excel, HTML or PDF. The controller returns a View and a Model; the Model is a Map of arbitrary objects that the View renders. For example, Spring's DispatcherServlet handles all incoming web requests. The view layer causes the rendering of the response from a controller in a manner suitable for the particular client. The view layer can be implemented, for example, by a view class.

The application tier includes the application specific logic, and can include three layers: the services layer, business layer, and a persistence layer. The service layer can encapsulate most of the use cases for the IPDP system. This layer may not maintain any state. The stateless nature allows for multiple concurrent calls into the methods without side effects. Moreover, the service layer methods are coarse-grained. This means that a single method invocation will accomplish the corresponding use case.

Security and transaction management can also be considered as service layer functions. Spring Security is configured declaratively and provides for URL-based as well as service-method based security. Spring transactions allow for declarative demarcation of transaction boundaries.

The business layer can be an optional layer which is invoked by some service-layer methods optionally. The business layer, in general, encapsulates most of the business logic functionality.

The persistence layer includes most of the functionality to support persistence of data in support of the applications on IPDP servers. This layer may include functionality to access remote databases etc.

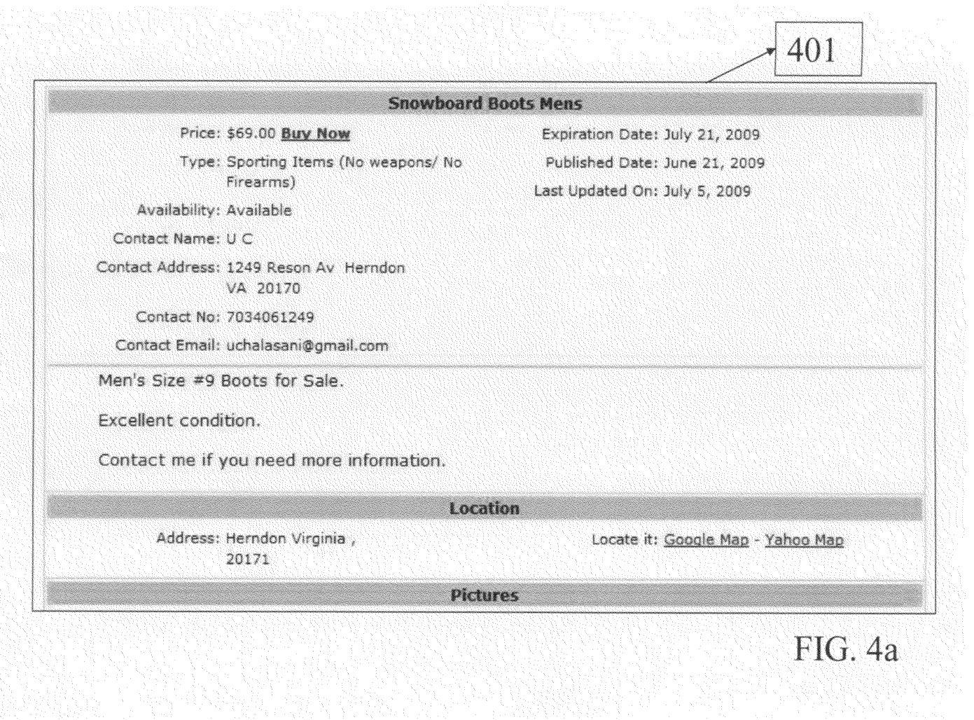

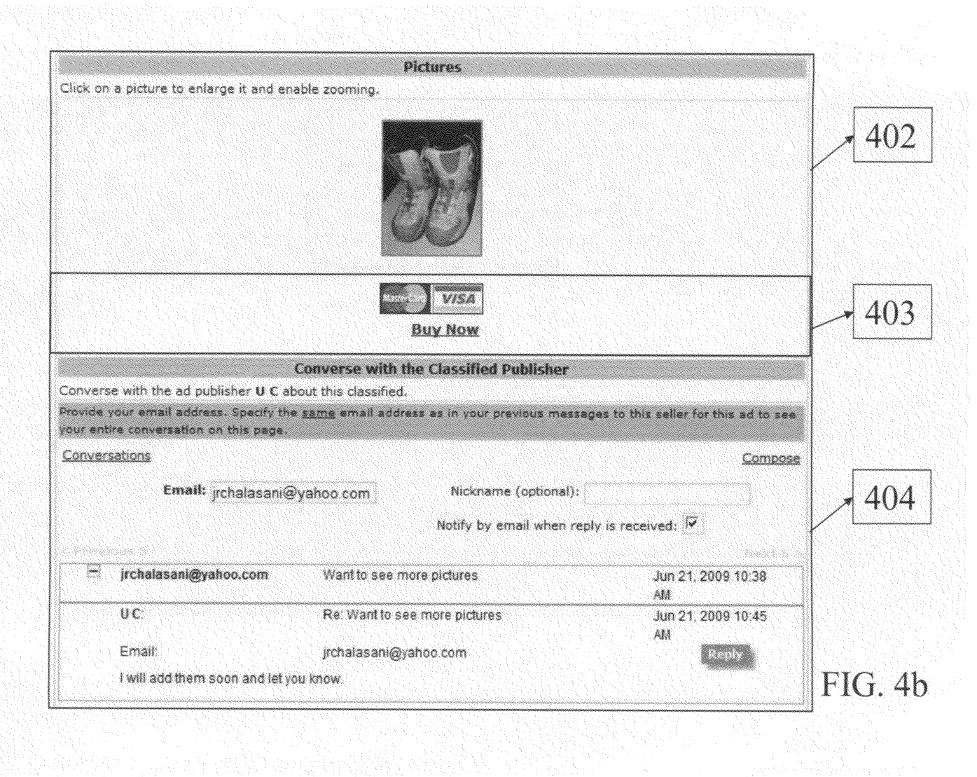

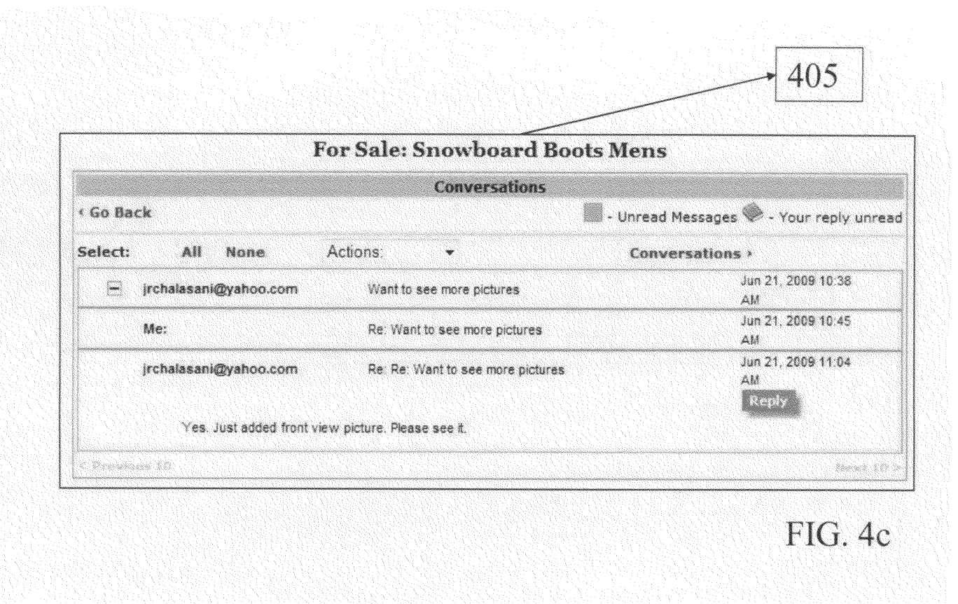

FIGS. 4a, 4b and 4c show a web-page rendered by the IPDP system for a classified advertisement. FIGS. 4a, 4b and 4c show the same web-page scrolled to different extents. 401 and 402 show the details and an image of the item for sale advertised in the classified advertisement. 403 show payment options. Clicking on any payment option can cause necessary information for the user being pre-filled into a payment form or payment request. For example, if the user is a buyer who has previously purchased from this seller, the seller may have the buyer's information in his contact information or smartBook. The information from the smart book can be automatically used for pre-completing the fields of a payment request form so that the burden on the buyer is reduced.

A conversation between the seller and buyer is shown in 404. The direct integration of modules such as the conversation module and the payment module within context of the subject content (e.g., classified advertisement) is a significant feature provided in the present invention. 405 illustrates the conversation of 404 as it has progressed. The in-context ability to view conversations leads to substantial advantages such as, for example, in ease of use, and the ease of keeping track of items and related conversations.

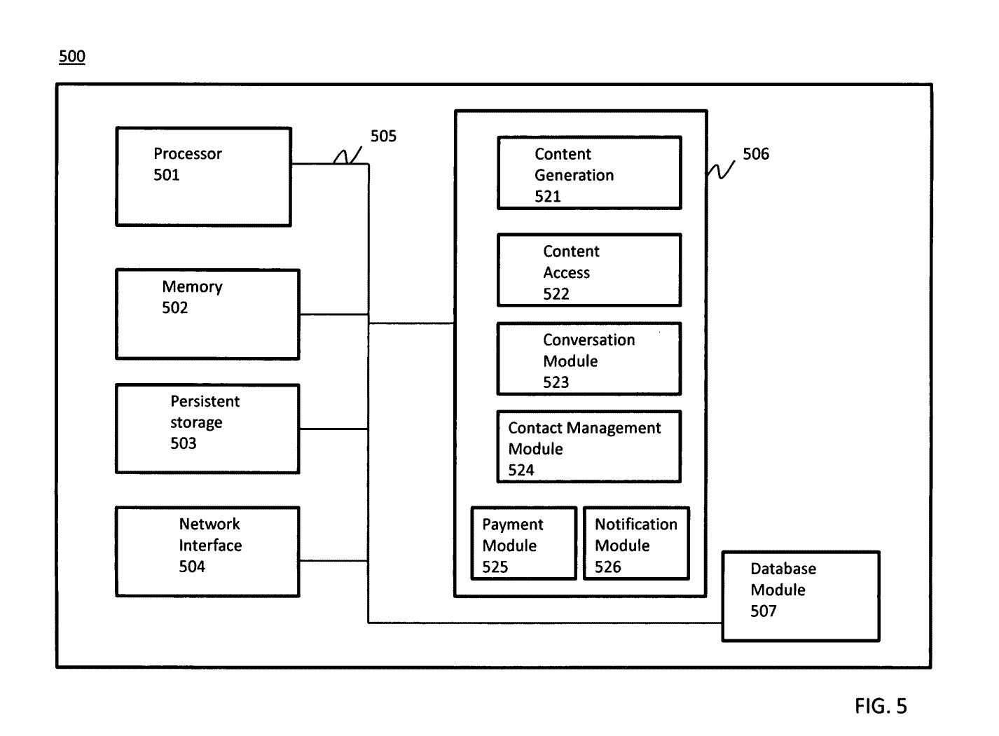

FIG. 5 shows an IPDP system according to an embodiment of the present invention. The IPDP system 500 includes one or more processors 501, one or more memories 502, one or more persistent memories 503, one or more network modules 504, one or more communication modules 505, an IPDP module 506, and a database module 507. IPDP module 506 can include a content generation module 521, a content access module 522, a conversation module 523, a contact management module 524, a payment module 525, and a notification module 526. It should be understood that IPDP system 500 can also include other software and hardware modules, and/or different combinations of the software and hardware modules shown.

One or more processors 501 (herein referred to as processor 501) can include commercially available processors such as, but not limited to, central processor units, or specialized processors such as digital signal processors. One or more memories 502 (herein referred to as memory 502) can be a non-persistent memory device such as a dynamic random access memory. One or more persistent memories 503 (herein referred to as non-persistent memory 503) can include, but are not limited to, a magnetic or optical hard disk drive, a flash memory device, compact disc, or digital video disc media. One or more network modules 505 (herein referred to as network module 505) includes hardware and software functionality to interface between computers and/or computing devices. One or more communication devices 506 (herein referred to as communication device 506) can include, but are not limited to, computer-internal communication devices such as peripheral component bus (PCI), universal serial bus (USB), and/or local area networks, wide area networks or other networks used for distributed computer systems.

IPDP module 507 includes the logic for implementing methods for task management according to the present invention. The logic and functionality of IPDP module 507 can be implemented using software or hardware or a combination of the two. Database module 508 includes the functionality to store and to manage any data, such as task management data, that is used in IPDP module 507. Database module 508 can include commercially available third party database management systems, or any custom-developed modules for the storing and management of data.

IPDP module 507 can include a content generation module 521, a content access module 522, a conversation module 523, a contact management module 524, a payment module 525, and a notification module 526. An implementation of IPDP module 507 can include some or all of the modules 521-526 and/or other additional modules in keeping with the present invention. A computer program product can include the logic instructions for implementing IPDP module 507, and may be stored on computer readable media such as a persistent memory device. In one embodiment of the present invention, logic instructions for implementing IPDP module 507 is implemented in software, using one or more programming languages and scripting languages such as, but not limited to, C, C++, Java, AJAX, Perl, Java Servelets, and XML.

Content development module 521 includes the functionality to develop, create, edit, and/or maintain task management content including web pages. For example, some of the functionality for web page creation was described above. Content development module 521 can include the functionality, for example, for a seller of an item to develop the content of a classified advertisement using an editor. Content development module 521 can also include any parsers, compilers and debuggers required for the development of the task management content.

Content access module 522 includes the functionality to enables users to access content stored on the IPDP system. For example, task management content stored on IPDP system such as that developed by sellers of items and stored on IPDP servers on persistent memory devices 503 can be accessed by users through the web. Authorizing and/or authenticating users, such as sellers and buyers using the IPDP system, and assigning levels of authorized access to such users can be accomplished using content access module 522. The security functionality and the access control functionality described above, for example, can be implemented using content access module 522.

Conversation module 523 includes the functionality for the creator/developer of the task management content to communicate with others accessing the task management content on a one-to-one or one-to-many basis. For example, the feedbox functionality described above can be implemented in conversation module 523. Conversation module 523, for example, can allow the conversation to be displayed in context with the task management content as shown in FIGS. 4a-4c.

Contact management module 524 includes the functionality to maintain information about individual entities, such as customers and sellers, within the IPDP system. Contact management module 524 can include the functionality of personal profiles, address books, and smart book functionality describe above. For example, contact management module 524 can include the functionality for the developer of a classified advertisement task management content to maintain a potential customer list that is automatically kept updated with respect to other registered users of the IPDP system.

Payment module 525 includes the functionality to allow persons using the IPDP system to make payments using payment processing options. For example, payment processing module 525 enables the developer of the task management content such as a classified advertisement to embed payment processing options within the classified advertisement such that a potential buyer of the advertised item can simply select one or the embedded payment options. The selection of a payment processing option by a potential buyer from within the payment processing options embedded in the task management content, can cause the system to automatically fill in (pre-fill) all or some of the information to complete the payment processing. Prefilled information can include, but is not limited name and address information, credit card information, etc. Some of the functionality of the payment module 525 is described above with respect to payment services.

Notification module 526 includes the functionality to allow the task management content developer, or various users of the task management content, to generate alerts based on changes to selected task management content. For example, a web page for a classified advertisement may be configured to generate an email to the seller whenever a potential buyer leaves a message using the conversation module (feedbox).

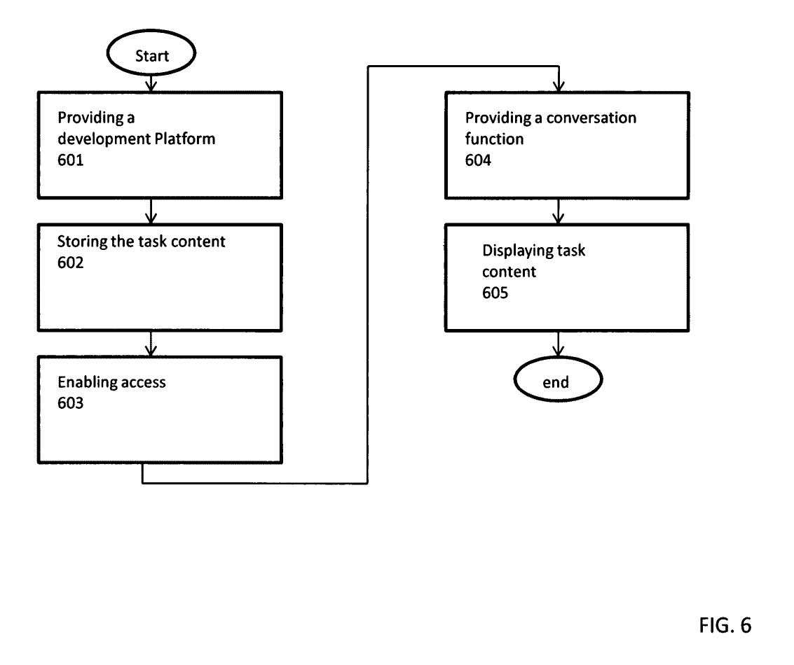

FIG. 6 shows a set of processing steps 601-605 for task management according to an embodiment of the present invention. In step 601, a platform for the development of task content is provided. For example, a web application development platform that includes an editor, a parser, a compiler, and execution platform may be provided. A seller of an item may, for example, log in to the IPDP system and use the provided application development platform to create and maintain a web page having a classified advertisement of the item to be sold. As noted above a classified advertisement created using the IPDP system can have coupled to it various additional functionality such as, but not limited to, a conversation, payment services, and notification services. An example of a classified advertisement web page having coupled to it within context, a conversation and payment services is shown in FIGS. 4a-4c.

In step 602, task management content, including none, some or all of the task management content created using the IPDP system can be stored within the IPDP system such that the content is accessible through a network such as the Web. The storing of the task management content can include organizing the task management content into one or more digital files organized in a directory hierarchy and/or hyperlinked as appropriate. The organized digital files are then stored in persistent storage, for example, in one or more persistent storage devices 503, and the IPDP system is configured to allow access to the content through the Web. For example, a web page for a classified advertisement, such as that shown in FIGS. 4a-4c can be stored in persistent storage device 503, and its address in the form of a uniform resource locator (URL) can be forwarded to any potential buyers. The creation, maintenance and storage of the task management content can be provided, for example, using task management content generation module 521.

In step 603, access to the task management content is enabled. For example, having stored the task management content in persistent storage in the previous step (step 602) the creator of that content may now specify who has access to it. Access rights may be specified to the entire task management content for a specific task, or to various parts of it. Access may also specified in one or more access levels. In one example, a classified advertisement may be accessible to anyone including persons who are not registered with the seller of the classified item and/or those who are not registered with the IPDP system as a whole. In another example, basic information of the classified advertisement may be available to anyone, and more detailed information can be made available to persons registered with the IPDP system, and yet more detailed information may be made available to one or more persons selected on some criteria such as enrollment in a value added service privilege. Security functions, such as user registration in the IPDP system, specifying access levels for task management content, verifying and/or authorizing and/or authenticating users for access to various parts of the task management content can be provided using content access module 522.

In step 604, a conversation function is provided such that a person accessing the task management content can converse and/or negotiate with the seller of the content and/or other persons accessing the content. The conversation function, such as that illustrated in 405, can be specified in various accessibility levels such as private and public. A private conversation can, for example, be visible only to the seller and a specific buyer. A public conversation coupled to a classified advertisement, for example, can be accessed by anyone who can access the classified advertisement. The conversation function can be provided by the conversation module 523 (also described as feedbox).

In step 605, the task management content is displayed to those who are accessing it. The display of the task management content may be based on an authorized access level. Also, the display of the task management content may include the display of a conversation feature, a payment feature, and/or notification feature. Using the displayed task management content, buyers can for example complete the purchasing of an item advertised for sale, after negotiations etc., using the conversation function.

Above, one or more embodiments of the present invention have been described. A person of skill in the art will understand that various other applications and features are enabled by the present invention.

We claim:

1. A network-based method for task management, the method comprising:
providing a development platform to task owners for creating a task content;
storing the task content in one or more networked servers;
enabling access for task customers to access the task content;
providing a conversation function coupled to the task content; and
displaying the task content and a conversation to the task customers, wherein the conversation is an exchange of messages between two or more parties, and wherein the conversation uses the conversation function.

2. The method of claim 1, further comprising:
providing a payment function coupled to the task content.

3. The method of claim 2, further comprising:
displaying the task content and one or more payment options, wherein the one or more payment options each use the payment function to enable the task customers to make a payment.

4. The method of claim 1, wherein providing a development platform to task owners for creating a task content comprises:
authorizing the task owner for access to a task owner account;
providing access to one or more task content development modules from within the task owner account; and
providing access to one or more task management modules from within the task owner account.

5. The method of claim 4, wherein storing the task content in one or more networked servers comprises:
saving the task content, wherein the task content includes one or more web pages, and wherein the task content is accessible through a hyperlinked main web page.

6. The method of claim 5, wherein enabling access for task customers to access the task content comprises:
providing the task customer with an address for the hyperlinked main page.

7. The method of claim 1, wherein enabling access for task customers to access the task content comprises:
authorizing the task customer to access the task content;
providing access to the task content to the task customer;

8. The method of claim 7, wherein authorizing the task customer to access the task content, comprises:
assigning at least one of a plurality of access authorization levels to the task customer;

9. The method of claim 7, wherein providing access to the task content to the task customer comprises:
providing access to a first part of the task content based on the access authorization level of the task customer;

10. A network-based task management system, comprising:
at least one processor;
at least one memory coupled to the processor, the memory storing a task management server, wherein the task management server comprises:
a task content generation module;
a task content access module configured to control access to task content generated using the task content generation module; and
a conversation module wherein a conversation created using the conversation module is coupled to the task content.

11. The network-based task management system of claim 10, wherein the task management server further comprises:
a contact management module.

12. The network-based task management system of claim 10, wherein the task content creation module is configured to generate a task content, and wherein the task content is coupled to a conversation created using the conversation module.

13. The network-based task management system of claim 10, wherein the task management server further comprises:
a payment module.

14. The network-based task management system of claim 13, wherein the task content creation module is configured to generate a task content, and wherein the task content is coupled to a payment option created using the payment module.

15. The network-based task management system of claim 10, wherein the task management server further comprises a payment module, and a contact management module, and wherein the task content creation module is configured to generate a task content, wherein the task content is coupled to a payment option created using the payment module, and wherein the payment option includes pre-filled data using the contact management module.

16. The network-based task management system of claim 10, further comprising:
a database module.

17. The network-based task management system of claim 10, wherein the task management server further comprises:
a notification module.

18. A computer program product comprising a computer readable medium having computer program logic recorded thereon for enabling a processor to:
provide a development platform to task owners for creating a task content;
store the task content in one or more networked servers;
enable access for task customers to access the task content;
provide a conversation function coupled to the task content; and
display the task content and a conversation to the task customers, wherein the conversation is an exchange of messages between two or more parties, and wherein the conversation uses the conversation function.
